(19) United States
(12) Patent Application Publication
(10) Pub. No.: US 2025/0143259 A1
(43) Pub. Date: May 8, 2025

(54) Pet-Power Bell-Bowl Enhancing Pet Communication, Hydration and Nutrition

(71) Applicant: Anton Hicks, London (GB)

(72) Inventor: Anton Hicks, London (GB)

(21) Appl. No.: 18/388,169

(22) Filed: Nov. 8, 2023

(51) Int. Cl. A01K 5/01; A01K 7/00

(52) U.S. Cl. CPC A01K 5/0114; A01K 7/00

(57) ABSTRACT

This invention empowers pets by helping them stay hydrated through a simple yet innovative mechanism. It features a lever attached to the rim of a pet bowl, operated by the pet, causing a bell to ring underneath the rim. The lever is connected to a shaft located on the bowl's rim, and when activated, an attached bolt under it swings the bell. The bell's weight ensures the lever quickly returns to its original position. This system enables pets to signal their need for food or water, fostering a unique form of communication between pet and owner. Pets can be trained to use this system, reducing dehydration risks.

### FIELD OF THE INVENTION

This invention pertains to a pet hydration and communication system. It addresses the need for pet hydration while allowing pets to actively communicate their thirst, or hunger, to their owners. The invention comprises a pet bowl with a lever or see-saw button mechanism, a shaft, bolt, bell or gong, and training pets to interact with the device to call owners.

### BACKGROUND OF THE INVENTION

The background description includes information that may be useful in understanding the present invention. It is not an admission that any of the information provided herein is prior art.

Over the last four years, YouTube and Meta has shown dogs, cats and pigs interacting with bells to request food with millions of views and overwhelmingly positive comments. But these videos do not address pets' ability to request water (or food) via their bowl.

The environmental impact of meat-rich wet pet food has been reported to cause eight times more emissions than dry food. This environmental concern is reflected in a headline from The Guardian in November 2022 which talks about the carbon footprint of pets. So, pet owners are slowly switching to drier food options. This trend, along with hotter weather and our increasingly distracted lifestyles, underscores the need for solutions to tackle pet dehydration.

I recall being reminded by my father as a child to ensure my dog had water. And 40 years later, I found myself reminding my own family members to attend to our pet's hydration needs. Often pets can't communicate their needs. Hence, the conception of a solution.

While searching for existing products on Amazon, Alibaba and Walmart, and pet-focused megastores like Petco and Petsmart, as well as the UK's IPO, USPTO, Espacenet, and specialized searches like PQAI, no product similar to the Pet-Power Bell Bowl was found. The closest bowl-results found had mechanisms to notify the owner when the bowl is empty(ing) or when it's time for a pet to be fed. Sophisticated as some of these are, they cater just for the owner. No bowl considers the pet's direct communication in the process. This lack of agency occurs whether pets want food or water. The Pet-Power Bell Bowl caters for either. So, like glass mirrors were invented in 1835, and cars in 1886—yet recent patents protect the value and difference of mirrors on and in cars—there is value and difference in my bell being on and in (the rim of) a bowl.

### SUMMARY OF THE INVENTION

This invention incorporates a lever or see-saw button positioned on the rim of the pet bowl. The lever is connected to a shaft located within a bracket atop the bowl's rim. When the pet interacts with the lever, a bell located underneath the rim rings, providing an audible signal to the owner. The bell's weight ensures that the lever quickly returns to its original position.

### BRIEF DESCRIPTION OF THE DRAWINGS

1/5 illustrates a side-top view of the pet-power bell-bowl, in accordance with an embodiment of the present disclosure.

2/5 is a cross-sectional view of the pet-power bell-bowl illustrating especially the lever, shaft and bolt inside the bracket in similar accordance.

3/5 illustrates a top view of the pet-power bell-bowl with the seesaw button in situ.

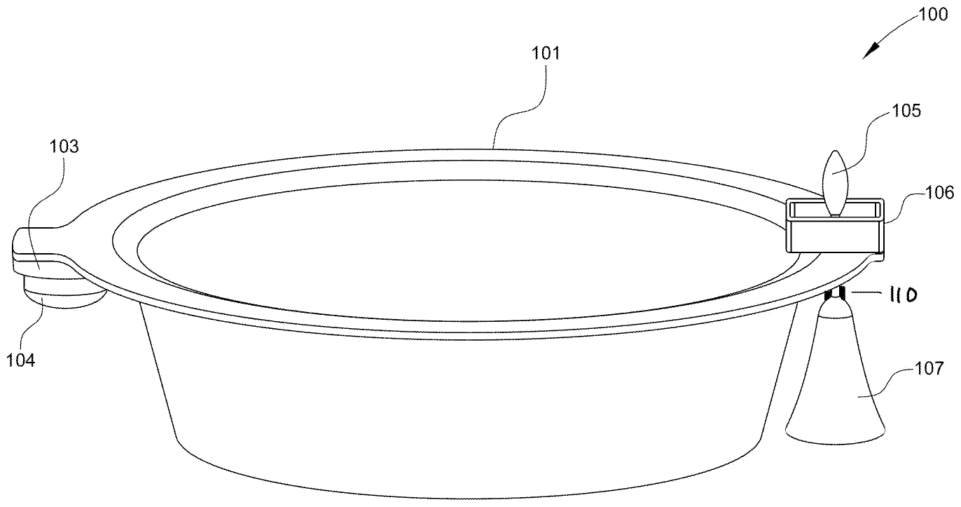

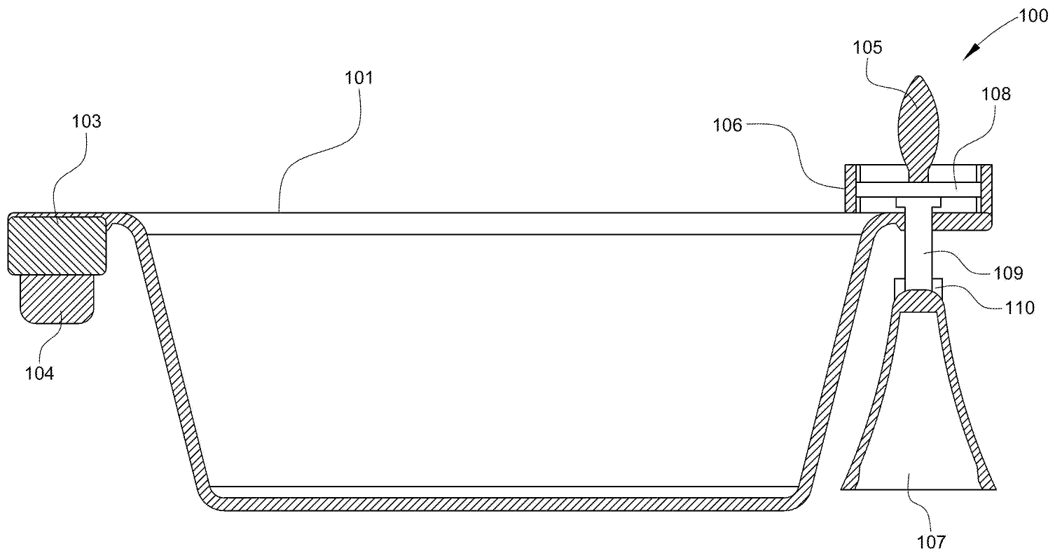

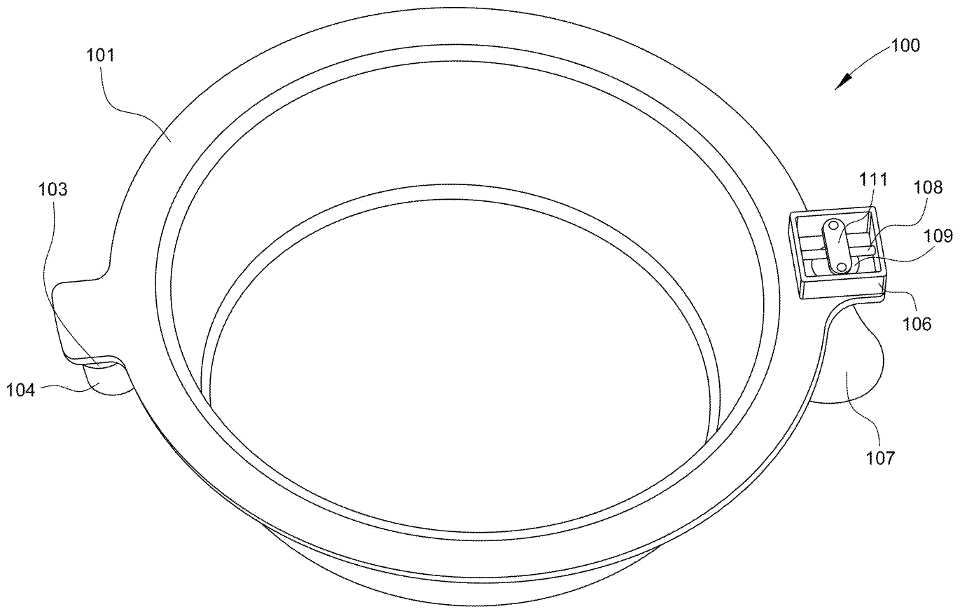

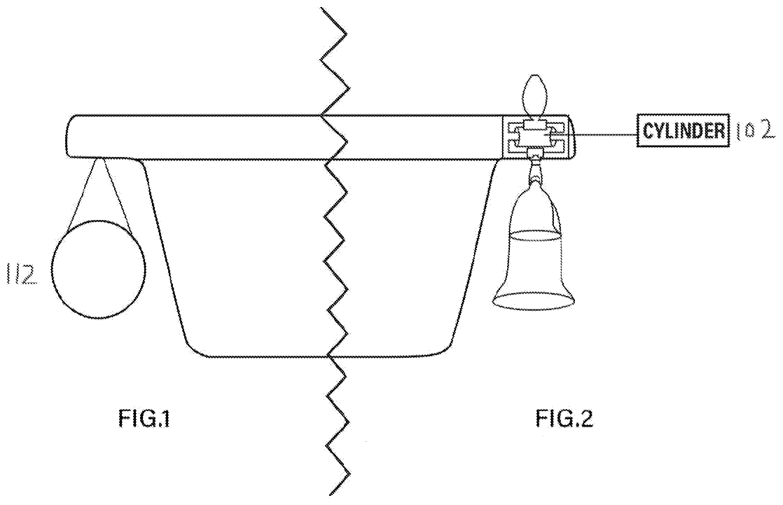

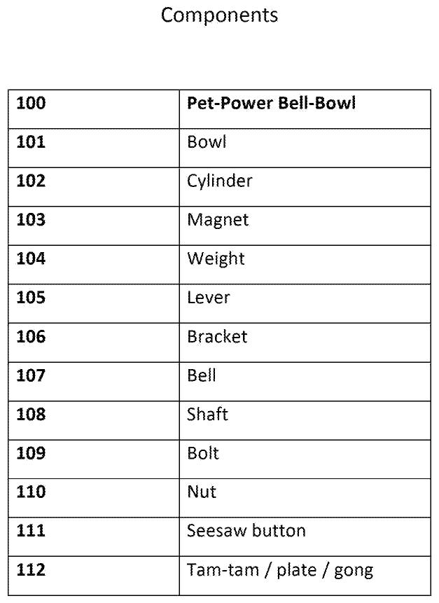

4/5 illustrates two design options of the pet-power bell-bowl, in similar accordance. FIG. 1 shows a tam-tam, or plate, of the gong option in accordance with an embodiment of the present disclosure. FIG. 2 shows use of a cylinder in similar accordance. In reality, the cylinder mechanism would be on the surface, not the side, of the rim. If the shaft is part of the rim (para 30), then a cylinder is necessary. If the shaft is inside a bracket atop the rim (para 28), it is not.

Elements in the drawings may not be to scale. They may show only details pertinent to understanding the embodiments of the invention so as not to obscure the drawings with details readily apparent to those of ordinary skill in the art having benefit of the descriptions. And in the language about to be used, no limitation of the scope of the invention is thereby intended.

### DETAILED DESCRIPTION OF THE INVENTION

This pet bowl features a lever or see-saw button positioned on the rim of the bowl. A shaft, securely located within a bevel-edged bracket atop the bowl's rim, is fixed to this lever. When a pet pushes or pulls it, a bell located beneath the rim chimes, alerting the owner.

This invention includes a bracket or frame affixed to the rim of the pet bowl. The attachment can be by, for instance, welding or with right-angled brackets. If the latter, one side is affixed to the primary bracket, the other side is anchored to the bowl itself.

In an embodiment, the lever is securely affixed to the shaft, possibly by welding. To maintain smooth, noise-free operation, the shaft can be lightly lubricated with grease or graphite.

At the center of the bracket, a hole in the rim is created, serving as the anchor point for a swinging bolt. When the pet pushes or pulls the lever, it instigates the movement of the shaft, which, in turn, causes the attached bolt to swing. The movement (pivoting, turning, swivelling) will be about a quarter of the way round. This bolt is fastened to a bell positioned beneath the rim. The bell is designed with a deep nut, which is firmly affixed, typically through welding,

The invention offers the option of providing both large and small bells, each equipped with fixed deep nuts of the same size. This uniformity simplifies adjusting the ‘volume’ of the bell. By holding the large bell itself, it can be easily screwed onto the bolt, creating a louder and more resonant sound. Conversely, the bell can be unscrewed, and replaced with a smaller bell.

In an embodiment, there is no screw-in bell-size-option, but a fixed (medium-size) one.

In an embodiment, the material selection for the Pet-Power Bell Bowl offers versatility. It could be brass, (recycled) plastic or stainless steel. For a customized experience, the bowl could be crafted from stone, albeit at a higher cost. Stone adds an aesthetic dimension, evoking a monastic ambience. A ‘spiritual’ buyer might order a stone bowl with (para 24) a gong.

Both dogs and cats see yellow and blue. So, a blue drop-shaped lever is suggested. The rounded shape eliminates sharp edges. The lever would likely be hollow plastic or hollow steel to save on materials and be lighter, helping the lever's swift return to verticality after being pushed or pulled. (If a bell-bowl is used for food, the lever could be cats' and dogs' other color, yellow.)

Ensuring the bowl's stability, a magnet on the opposite side of the bowl holds a weight in place, matching the weight of either the large or the small bell. Both magnets will be supplied.

The lever, 105, whose effects could also be created by a see-saw button 111, is the central component that the pet interacts with to ring the bell, 107. The lever, easily movable by the pet's paw or nose, will make the shaft, 108, turn. The bracket 106 is securely attached to the rim of the bowl, the bracket holds and protects the shaft and its two joins (of lever and bolt). The bolt, 109, is fixed to the shaft and swings—rings—the bell when the lever is moved. The nut, 110, is affixed to the bell, fastening the bolt in place to ensure a tight connection between it and the bell. The bell, 107, beneath the bowl's rim, rings when the pet activates the lever.

After food and drink, a really smart pet might be trained to ring the bell twice when he needs to go outside, or three times when he's in the mood for a specific bone or toy.

In an embodiment, the Pet-Power Gong.com is the same mechanism, but without a bell. An elongated bolt or rod becomes the gong's mallet. A rubber ball, aluminium, hard wood, or any wash-or wipe-able material suitable for use as a gong head can be employed. The gong head is known as a ‘hammer,’ just as a ‘hammer’ from outside (sometimes called a ‘clapper’ inside) strikes any bell.

The size and softness of the gong head are adaptable to the dimensions of the gong itself. In the case of a smaller gong, a smaller and firmer hammer may be employed, whereas a larger gong would be paired with a larger and softer hammer for optimal sound quality and resonance.

Of the three types of gong, this specific type is akin to a ‘suspended gong’, which is a flat, circular disc of metal hung vertically usually using strong cord threaded through holes near the top rim of the disc. This disc is also known as a tam-tam. A hook, fixed onto the underside of the rim, is a possible anchor point for the cord. It allows the part of the tam-tam to be struck to hang at or near the same location where a hammer would strike a medium-sized bell.

In an embodiment of the Pet-Power Bell-Bowl or Pet-Power Gong.com, the lever is replaced by a long, preferably oval, flat button situated within the bracket. The button is centrally affixed atop the shaft and bisected underneath by the shaft itself. Much like the fulcrum of a seesaw, the shaft serves as the pivot point for the button. In the case of this button, the fulcrum isn't anchored to the ground, as seen in some children's seesaws, but instead is attached to the switch within the bracket. When a pet pushes down on one end of the bisected button, it causes the other end to rise, turning the shaft. This moves the shaft exactly as the lever does.

In an embodiment, of the Pet-Power Bell-Bowl or Pet-Power Gong.com, a cylinder is introduced around the shaft. The shaft remains fixed in place, while the cylinder is responsible for movement. A bolt is securely affixed to the underside of the cylinder, much like the original design, where the bolt was attached directly to the shaft. So, the utility and result are the same.

However, the cylinder is an additional moving part which brings a risk of the shaft or cylinder becoming loose or developing a rattling noise which could be both annoying to pets and humans. Moreover, food particles, saliva, and dirt could fall into this unnecessary mechanism.

A simplified embodiment for the Pet-Power Bell-Bowl or gong bowl envisions no bracket at all. A strip of the bowl's rim serves as the central shaft. This means creating a narrow cut-out on the rim, for example a 1 cm by 1 cm square, with a strip of material left in the middle of the bisected square around which a (this time, essential) cylinder is placed. All else is the same.

However, the shaft-strip, would need to be relatively thick to withstand the forces involved, especially from an inadvertent or playful downward press. Rounding the strip to enable the cylinder to swivel could weaken the structure. So, the entire bowl, or at least its rim, would need to be doubly or triply thick from the outset to ensure sufficient strength . . . which is possible.

Another point of consideration is the attachment of the bell to the system. Rather than using a fixed bolt, the simplified design suggests using fasteners like a key-ring or hook, which are undoable. While this offers some flexibility, here's the possibility that the hook may slide around within the bell's clip without effectively moving the bell. In such cases, the side-to-side forces would be absorbed by the hook and clip, rather than being transmitted to the bell itself.

In the context of the Pet-Power Bell Bowl's patent specification, a brief introduction referencing Ivan Pavlov's classical conditioning experiments and its relevance to pet behavior is provided. I wanted to show you what I hope to show manufacturers or investors.

### Possible Instructions

From your school biology class, you may remember the 19^{th} century Russian physiologist-turned-psychologist, Pavlov. When his assistant rang a bell and fed the dogs, they salivated. Soon, just hearing the assistant approaching, they salivated without the bell or food. Pavlov had conditioned them. Now, your pet will condition you! When he or she rings, you come. (Don't worry, you'll still be in charge!) There'll be times when you can't respond. Like your friends may call, and it's too inconvenient. They'll call again. Just try to be consistent during training.
Training your pet—let's call him Bruno—to use the Pet-Power Bell-Bowl is a simple and rewarding process. It can be used for food or water. Does Bruno have dried food? Do the kids sometimes forget to check the water bowl? Imagine you've just enjoyed Bombay Mix, beef jerky and crisps but no drink, and you don't know how to ask for one. Now, imagine that all summer's day. It's real discomfort leading to danger. So, let's do Bruno's water first.
SETUP: Ensure the bowl is where Bruno usually has food or water. Screw on his size bell.
ENCOURAGE INTERACTION: Let Bruno approach the bowl to explore it alone for a while.
POSITIVE REINFORCEMENT: Place Bruno's paw or nose gently on the lever. If unsure which paw, just know that male cats and dogs usually use their left paw; females, their right.
(And the lever's blue—our nearest color to water—one of the colors cats, dogs and birds see.)
RINGING THE BELL: Guide Bruno to perform the same action on the lever that he usually does to get your attention, like pulling or pushing your arm. When the bell rings, immediately reward him with a “Good boy,” and immediately provide fresh water or his favorite drink in the bowl. Bruno always tries to learn from your reactions. If you don't act “immediately,” then you're already doing something else and—as far as Bruno knows—you're reacting to that. Confusing!
So, do as Pavlov did. Give Bruno a simple association: “Dry bowl, I ring, human fills.”
REINFORCE: Repeat this process several times over 2 or 3 days to establish the association. Don't completely fill a large bowl in each time, then you can return soon. Once he's trained, fill it.
ADDRESSING OVERUSE: If Bruno starts to ring the bell excessively or just for attention, look at the bowl, calmly say “No,” turn your back, and immediately resume your previous activity. Now, there's another association or bit of conditioning: “Rejection if/abuse human!”
If you leave Bruno alone for extended periods, it's your responsibility to ensure he or she has access to water. Treated right-we mean, Bruno and his bell-a whole new level of trust and communication will develop between you. The experts keep telling us not to forget to have enough water. Now, Bruno won't allow you to forget to water him.
And using the Pet-Power Bell-Bowl for food is the same game. Yes, make it a game. But don't have the same bowl for food and water. Messy! Have a second bowl. And if using the lever version for water, try the seesaw switch or gong version for food. Enjoy yourselves. Mix it up . . . just not in the same bowl.

1. A pet hydration or feeding device comprising:
a. a pet bowl;
b. an actuation device affixed on a shaft or a cylinder around it;
c. the shaft to turn within a bracket on the bowl's rim;
d. a bolt affixed under the shaft or the cylinder around it, going through the rim, to hold a bell that may be changeable;
e. a counterbalancing weight held, for example, by a magnet or hook attached to the rim diametrically across from the bell.

2. The pet hydration device of claim 1 wherein the shaft is replaced by a rounded strip of the bowl's rim about which a cylinder rotates.

3. The pet hydration device of claim 1 wherein, replacing the bell, the bolt is elongated to become a gong's mallet whose hammer strikes a metal plate suspended nearby from the bowl's rim.
